(19) United States
(12) Patent Application Publication
(10) Pub. No.: US 2003/0070297 A1
(43) Pub. Date: Apr. 17, 2003

(54) Method for fabricating external-tooth gears

(76) Inventor: Masataka Nakaoka, Ohbu-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/242,364

(22) Filed: Sep. 13, 2002

(30) Foreign Application Priority Data
Sep. 13, 2001 (JP) 2001-277761

(51) Int. Cl. B23P 15/14

(52) U.S. Cl. 29/893.34

(57) ABSTRACT

There is provided a method for manufacturing an external gear with a maintained high quality at low cost, which maintains a lubricated state of tooth flanks of the external gear with smaller manufacturing steps than the conventional method. The method for manufacturing an external gear internally in mesh with an internal gear inside the internal gear includes: a cold forging step of setting a material 80 in a lower cold forging die 100 having a tooth profile forming part 102 on an inner periphery of a circular recess 101 thereof, and pressing the material 80 so as to extend outward in the radial direction in order to form the material into a disc 81 and simultaneously, form an external tooth profile on the outer periphery of the disc 81; and a punching step of punching the disc 81 to form holes 11, 15, 17 required for constituting a power transmission mechanism. The surface roughness of the tooth flanks due to the cold forging is maintained on the completed product.

### BACKGROUND OF THE INVENTION

1. Field of the Invention

The present invention relates to a method for manufacturing an external gear internally in mesh with an internal gear inside the internal gear, and particularly relates to a method for manufacturing (or fabricating) an external (tooth) gear for use in a gear power transmission apparatus where a center of the internal gear exists inside a periphery of the external gear.

2. Description of the Related Art

A gear power transmission apparatus having an internal gear, and an external gear internally in mesh with the internal gear inside the internal gear with a center of the internal gear being inside a periphery of the external gear is widely known as a power transmission apparatus classified in the International Patent Classification of F16H 1/32.

As a typical example of this type of the power transmission apparatus, there exists an internally meshing planetary gear structure. Such internally meshing planetary gear structure includes: a first shaft; eccentric bodies rotating along with the rotation of the first shaft; a plurality of external gears which are mounted on the eccentric bodies through a bearing for eccentric rotation; an internal gear internally in mesh with the external gears through internal teeth constituted by external pins; and a second shaft connected with the external gears through internal pins for extracting only a rotation component of the external gears.

FIG. 4 and FIG. 5 show a conventional example of this structure. In this conventional example, the structure above is applied to a “reducer” by setting the first shaft and the second shaft to an input shaft and an output shaft respectively, and simultaneously, fixing the internal gear.

In FIG. 4 and FIG. 5, reference numeral 1 denotes a reduction gear casing. The reduction gear casing 1 includes a first casing 1A and a second casing 1B on the both ends, and a main body casing 1C at a center which also serves as an internal gear 7. Reference numeral 2 denotes an input shaft, reference numeral 3 denotes an output shaft, reference numerals 4 and 5 denote bearings for rotationally supporting the input shaft 2, and reference numeral 6 denotes a bearing for rotationally supporting the output shaft 3. The input shaft 2 and the output shaft 3 are coaxially provided. The bearing 6 for supporting the output shaft 3 is engaged with the first casing 1A.

The gear power transmission mechanism in this reducer comprising two eccentric bodies 8 provided on an outer periphery of the input shaft 2 so as to integrally rotate with the input shaft 2, two external gears 10 mounted on an outer periphery of the eccentric bodies 8 through bearings 9 so as to eccentrically rotate with respect to the input shaft 2, and the internal gear 7 serving also as the casing internally in mesh with the external gears 10. The bearing 9 for supporting the external gear 10 around the eccentric body 8 is fitted into a center hole 11 on the external gear 10. External teeth with a trochoid tooth profile or a circular arc tooth profile are provided on an outer periphery of the external gear 10. Internal teeth comprising external pins 12 are provided on an inner periphery of the internal gear 7.

A pair of carriers 13 and 14 are provided on both sides of the two external gears 10. Both of the carriers 13 and 14 are integrally connected with each other by means of a plurality of carrier pins 16 passing through carrier pin holes 15 formed on the external gears 10. A plurality of internal pin holes 17 are provided on the external gears 10, and an internal pin 18 is loosely engaged with the internal pin hole 17. As a result, only the rotation component of the external gear 10 is transmitted to the carriers 13 and 14 on the both sides through the internal pins 18.

The carrier 14 on one end side of the reducer is integrally formed at the base end of the output shaft 3. The bearing 5 for supporting the input shaft 2 on the one end side is fitted into a recess formed on the carrier 14.

Also, the bearing 4 for supporting the input shaft 2 on the other end side is fitted into the inner periphery of the carrier 13 on the other end side. The carrier 13 on the other end side is rotationally supported inside the second casing 1B through a bearing 19. Then, the elements constituting the gear mechanism such as the input shaft 2 and the external gear 10 are built into the main body casing 1C also serving as the internal gear 7. Then, the first and second casings 1A and 1B are fixed to the main body casing 1C with bolts, resulting in completion of the reducer as shown in the drawings.

The following will describe the operation of this reducer.

As the input shaft 2 rotates by one rotation, the eccentric bodies 8 rotate by one rotation. As a result of the one rotation of the eccentric bodies 8, though the external gears 10 try to rotate oscillatingly about the input shaft 2, since the internal gear 7 constrains the rotation, the external gears 10 almost only oscillate while they are internally in contact with the internal gear 7.

When the number of teeth of the external gears 10 is N, and the number of teeth of the internal gear 7 is N+1, the difference in teeth number is 1. Consequently, as the input shaft 2 rotates by one rotation, the external gears 10 shift (rotate) by one tooth with respect to the internal gear 7 fixed to the casing 1. This means that the one rotation of the input shaft 2 is reduced to −1/N rotation of the external gears 10.

The oscillation component of the rotation of the external gears 10 is absorbed by a gap between the internal pin hole 17 and the internal pin 18, and only the rotation component thereof is transmitted to the output shaft 3 through the internal pins 18.

As a result, the speed reduction of −1/N (minus means a reverse rotation) is attained.

This internally meshing planetary gear structure is currently applied to various types of reduction gears and step-up gears. While the first shaft is set to the input shaft, the second shaft is set to the output shaft, and simultaneously the internal gear is fixed in the structure described above, a reducer may be constituted such that the first shaft is set to the input shaft, the internal gear is set to the output shaft, and simultaneously the second shaft is fixed, for example. In these structures, when the second shaft is set to the input shaft, a “step-up gear” is constituted.

The external gear constituting this type of the internally meshing planetary gear structure is conventionally manufactured following the steps below in this order. The following will describe these steps with reference to FIG. 6.

(1) A material is formed into a disc.

(2) Holes necessary for constituting a power transmission mechanism (the center hole 11, the carrier pin holes 15, and the internal pin holes 17) are bored on the disc.

(3) A trochoid tooth profile is formed with hobbing on the outer periphery of the disc.

Either the step in (2) or the step in (3) may come first.

(4) The surface hardening is applied to tooth flanks with a heat treatment.

(5) The center hole 11 is finished with grinding or cutting, and the internal pin holes 17 are finished with the center hole 11 as a reference.

(6) The tooth flanks are ground. In this process, the diameter of a grinding wheel is set sufficiently larger than the face width for securing efficiency and precision, and the grinding wheel is rotated in the tooth trace direction so as to grind the tooth flank with the peripheral surface of the grinding wheel. Then, irregularity on the tooth flanks generated during the hobbing is removed. An arrow S indicates the tooth trace direction, and an arrow K indicates the tooth profile direction.

The completed external gear before being built into the power transmission mechanism is obtained after the final grinding as described above. Then, the following steps may be added.

(7) Shot peening or barrel finishing is applied.

(8) Chemical conversion is applied.

The chemical conversion in (8) is technology for forming a chemical conversion film such as a phosphate film on a sliding part so as to reduce friction coefficient of the sliding part. The chemical conversion film itself does not have a low friction coefficient, but has fine irregularity holding a large quantity of lubricant to reduce the friction coefficient.

As described above, the tooth profile is formed by hobbing, and additionally, grinding is applied to the tooth flanks after the hobbing for intentionally removing the surface roughness generated by the hobbing in the conventional manufacturing method for the external gear. However, since the hobbing for forming the tooth profile is to cut the tooth one by one, the cost of machining is high. Also, since the grinding finish is applied to the tooth flanks for removing the surface roughness of the tooth flanks after the hobbing, the number of the steps increases accordingly, thereby leading to an increase of the manufacturing cost.

### SUMMARY OF THE INVENTION

An object of the present invention is to provide a method for manufacturing (or fabricating) an external (tooth) gear which maintains a lubricated state of tooth flanks of the external gear while a tooth profile machining method for largely reducing the manufacturing cost is adopted.

The present invention solves the problems above with a method for manufacturing an external gear internally in mesh with an internal gear inside the internal gear. This method includes a cold forging step of forming a material into a disc, and simultaneously forming teeth on the outer periphery of the disc by a cold forging technique, and a step of forming a hole required for constituting a power transmission mechanism on the disc obtained in the cold forging step. Surface roughness of tooth flanks caused by the cold forging is maintained on a completed product.

With the method of the present invention having the constitution described above, since the tooth profile is formed by the cold forging, and simultaneously the tooth flank roughness of the tooth profile formed in the cold forging is maintained on the completed product, fine irregularity is left according to surface roughness of a die surface of the cold forging, and thus the irregularity holds the lubricant. Consequently, this facilitates a lubricant film formation on the tooth flanks, thereby reducing meshing resistance, and wear. As a result, since the mesh noise is reduced, and the efficiency is increased, performance required for this type of the gear is satisfied, and simultaneously, the performance can be maintained for a long period. In addition, above all, manufacturing time is reduced by eliminating the grinding, and manufacturing cost is reduced by eliminating a grinding apparatus.

Also, since work hardening is expected on the tooth flanks due to an effect specific to the cold forging, the external gear can be directly used for a power transmission mechanism with a low load and the like even if the heat treatment is skipped in the later step. Thus, it is especially preferable to apply this external gear without the heat treatment to a power transmission machine with a low load and a low cost. Of course, since the heat treatment in the later step increases the strength of the tooth flanks, the external gear after the heat treatment can be applied to a power transmission mechanism with a high load.

Further, when the holes constituting the power transmission mechanism are formed with punching, since the entire tooth profile and the holes are individually formed in a single operation, which is different from the conventional hobbing, the manufacturing cost can be reduced. In addition, since the cold forging step and the punching step are individually conducted using respective single chucks, it is possible to easily maintain high position precision of the tooth profile and the individual holes according to the precision of the cold forging die and a punch die.

### BRIEF DESCRIPTION OF THE DRAWINGS

These and other objects and advantages of the present invention will become clear from the following description with reference to the accompanying drawings, wherein:

FIG. 1 is a drawing describing manufacturing steps of an external gear according to a first embodiment of the present invention;

FIG. 2 shows surface roughness of the tooth flank in the tooth trace direction on external gears manufactured in a conventional method and the method according to the present invention, FIG. 2(a) is a drawing showing the surface roughness when grinding, and then barrel finishing are applied after hobbing, and FIG. 2(b) is a drawing showing the surface roughness after cold forging;

FIG. 3 shows surface roughness of the tooth flank in the tooth profile direction on external gears manufactured in the conventional method and the method according to the present invention, FIG. 3(a) is a drawing showing the surface roughness when grinding, and then barrel finishing are applied after hobbing, and FIG. 3(b) is a drawing showing the surface roughness after cold forging;

FIG. 4 is a sectional view of an internally meshing planetary gear structure including the external gear to be manufactured in accordance with the method of the present invention;

FIG. 5 is a sectional view taken along the line V-V in FIG. 4; and

FIG. 6 is drawing describing the conventional manufacturing method of the external gear.

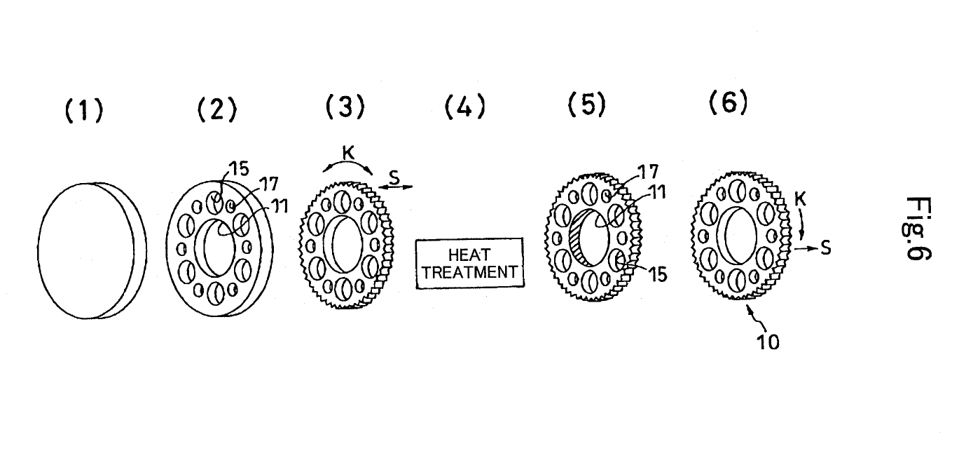

### DETAILED DESCRIPTION OF PREFERRED EMBODIMENTS

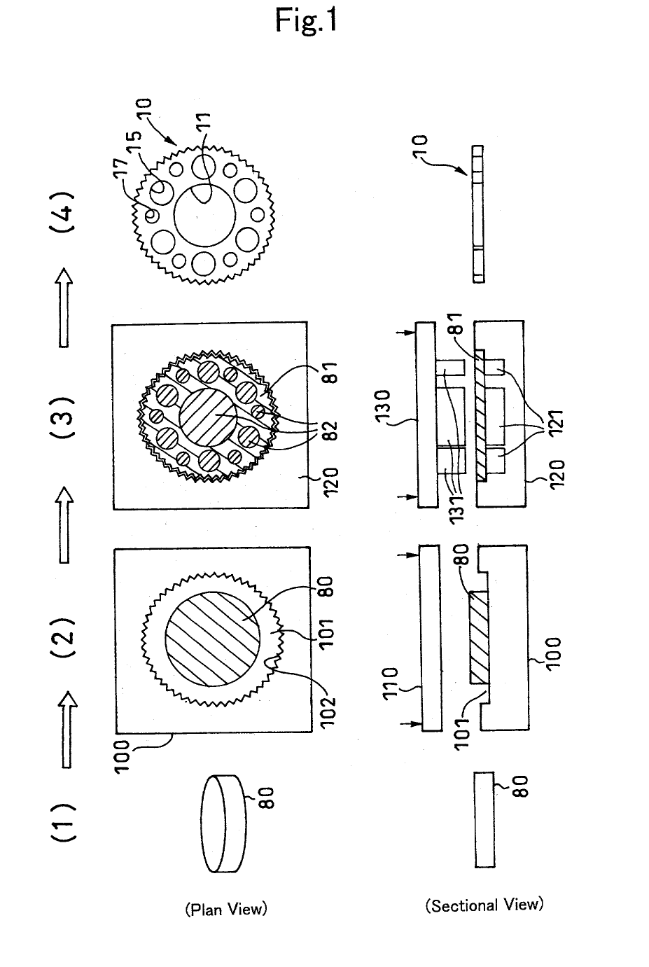

The following will describe embodiments of the present invention based on FIG. 1.

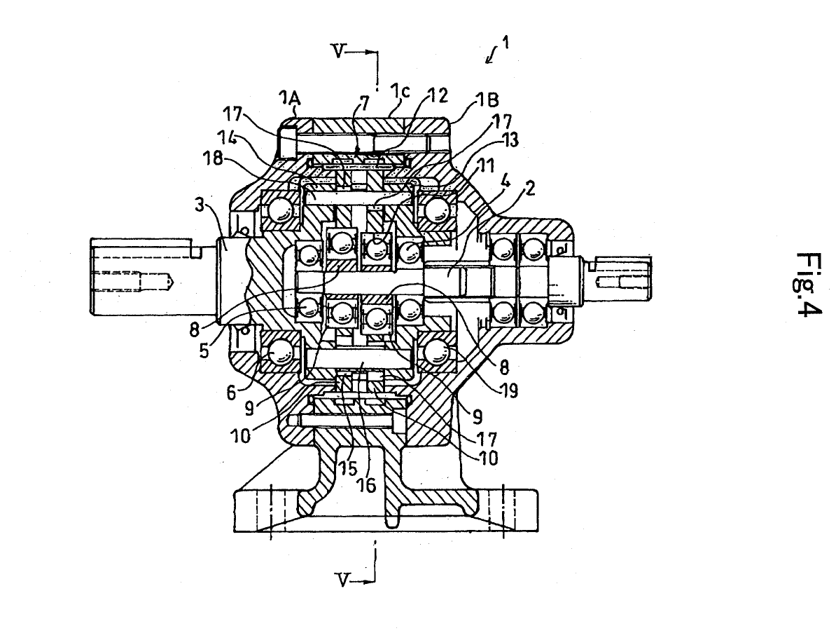

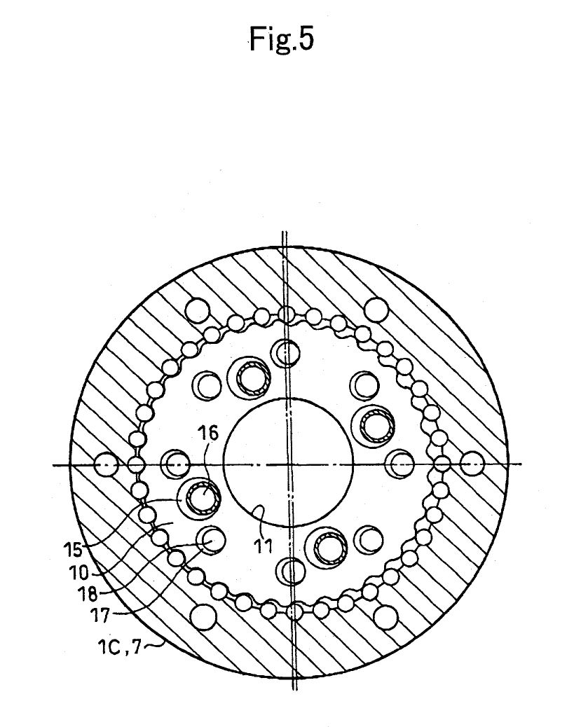

Since an external gear subject to manufacturing in this case is the same in shape as an external gear 10 shown in FIG. 4 and FIG. 5, the same numerals are used in FIG. 1.

The external gear 10 includes a trochoid tooth profile on the outer periphery, and according to a manufacturing method of a first embodiment, a completed product is obtained by conducting the following steps below in this order. The numerals enclosed by parentheses in the figure correspond to the following step numbers.

(1) A cylindrical material 80 is prepared. A material proper for cold forging such as SCM415 (chrome molybdenum steel) is used as this material.

(2) The cylindrical material 80 is set in a lower cold forging die 100 including a tooth profile forming part 102 on an inner periphery of a circular recess 101. Then, an upper die 110 is lift down to press the material 80 so as to extend the material 80 outward in the radial direction. As a result, the material 80 is formed into a disc 81, and simultaneously, an external tooth profile corresponding to the tooth profile forming part 102 is formed on the outer periphery of the disc 81 (cold forging step).

(3) The disc 81 is set on a lower punch die 120. Then, an upper die 130 is lift down so as to punch off unnecessary parts 82 in the disc 81 with recesses 121 of the lower die 120 and protrusions 131 of the upper die 130, thereby forming three types of holes (a center hole 11, carrier pin holes 15, and internal pin holes 17) necessary for constituting the power transmission mechanism (punching step).

(4) Consequently, the external gear 10 including the external teeth and the individual holes is obtained.

After conducting the steps above, the external gear 10 is obtained as a completed product. Namely, the external gear 10 is built in as an element of the power transmission mechanism while grinding the tooth flanks is intentionally skipped, and thus the surface roughness due to the cold forging is remained on the tooth flanks.

Since the tooth profile of the external gear 10 is formed in the cold forging step, and the holes are formed in the punching step in this way, the entire tooth profile and the entire holes are individually formed with a respective single operation, which is different from the conventional hobbing, and thus, the machining cost can be reduced. Additionally, since the cold forging step and the punching step are individually conducted using respective single chucks, it is possible to easily maintain high position precision of the tooth profile and the individual holes according to the precision of the cold forging dies and the punch dies.

Additionally, if the tooth flanks of the external gear 10 are maintained after the cold forging, and the following grinding is skipped, it is possible to form fine irregularity on the tooth flanks corresponding to the die surface of the cold forging die. Thus, since the fine irregularity on the tooth flanks hold a large amount of lubricant, this facilitates a lubricant film formation on the tooth flanks, resulting in reduction of friction resistance and long-term wear. As a result, noise is reduced and efficiency is increased, thereby providing predetermined performance as this type of the gear.

Further, since grinding is intentionally skipped, the machining time is reduced, and the machining cost is reduced due to eliminating a grinding apparatus. Consequently, the manufacturing becomes easy, and simultaneously, the manufacturing cost is reduced, thereby providing the product at a low price.

The following section describes a difference in the surface roughness of the external gear between in the conventional process and in the process of the present invention while referring to experiment data.

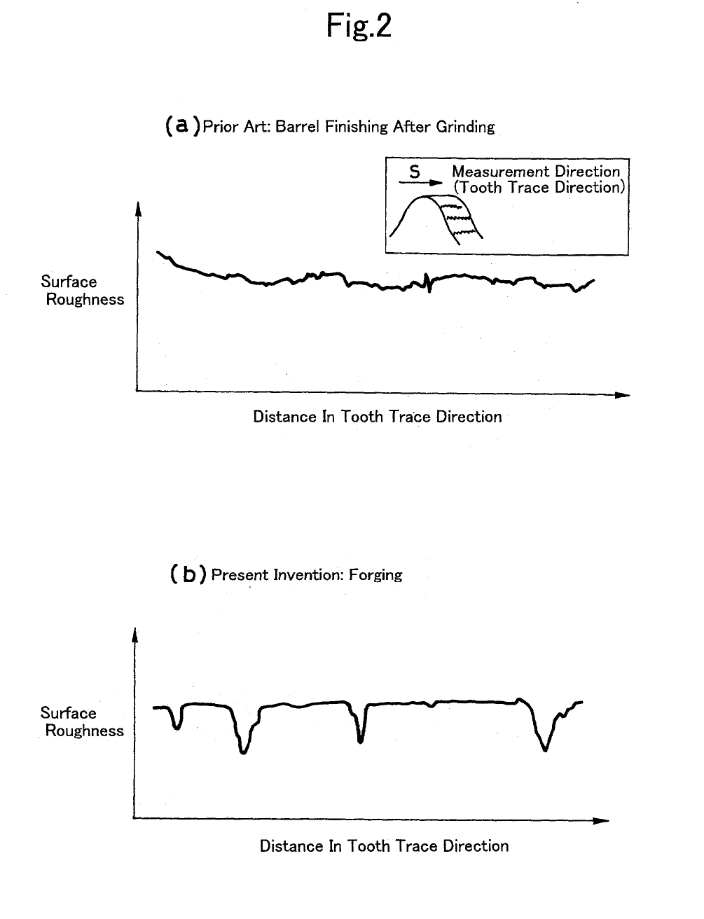

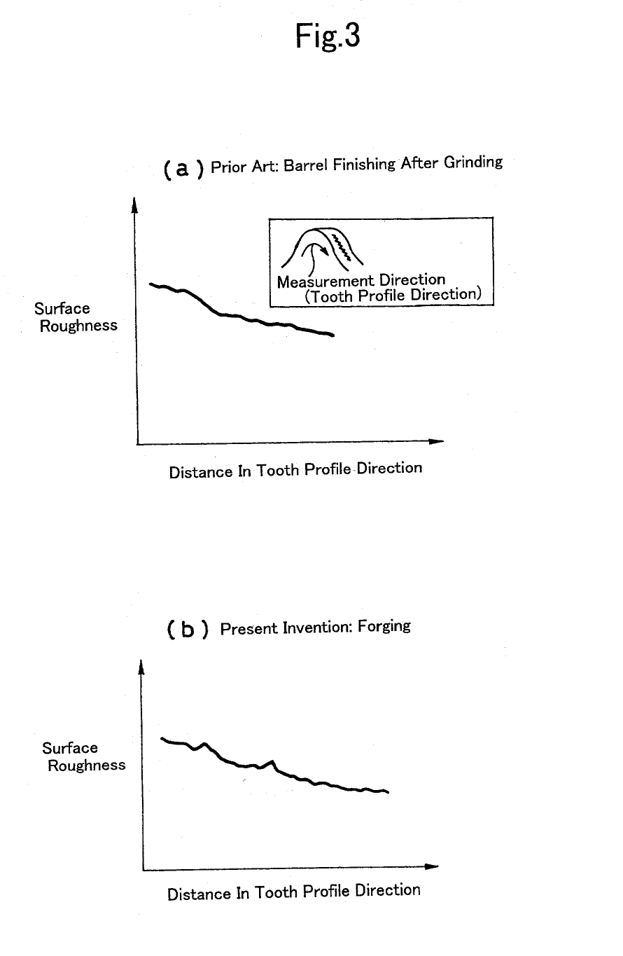

FIG. 2 shows roughness data measured in a tooth trace direction, and FIG. 3 shows roughness data measured in a tooth profile direction. The figure (a) shows data for the case where barrel finishing is applied after grinding (the conventional process), and the figure (b) shows data for the case where cold forging is applied (the process of the present invention) in the individual drawings.

When barrel finishing is applied after grinding (the conventional process), since a certain degree of smoothness is secured in both the tooth trace direction and the tooth profile direction, various characteristics required for this type of the external gear are sufficiently met (at least in an initial state).

However, the overall smoothness decreases the performance of holding the lubricant, and thus, the durability may decrease due to lack of the lubricant film on the tooth flanks depending on the operation conditions. Above all, the machining takes time, and simultaneously the machining cost is high.

On the other hand, when only the cold forging is applied (the process of the present invention), the irregularity larger than those in the case where barrel finishing is applied after grinding is remained in both the tooth trace direction and the tooth profile direction. This irregularity is rather large, and it is considered that this irregularity serves to form spaces for holding the lubricant.

Also, when the tooth profile is machined in the cold forging, since work hardening is expected on the tooth flanks, the heat treatment may be skipped in the later step depending on applications. Namely, the cold-forged product may be simply applied as a completed product to a power transmission mechanism with a low load and the like.

It is needless to say that the heat treatment is applied according to an application if necessary.

When the heat treatment is applied, it is preferable to apply finishing to the holes for adjusting distortion generated by the heat treatment.

In this case, the finishing is applied to the center hole 11 and the internal pin holes 17 while a plurality of predetermined positions on the tooth profile are supported as reference points. For example, the center hole 11 and the internal pin holes 17 are finished by grinding or cutting technique while three pins are in contact with three positions on the tooth profile to support it. After the heat treatment, if the finishing is applied to the center hole 11 and the internal pin holes 17, which are important for constituting the power transmission mechanism, while the three points on the tooth profile of the external gear 10 are set to references, it is possible to maintain the position precision of the holes 11 and 17 with respect to the tooth profile higher.

If it is necessary to secure the higher performance as the external gear, it is preferable to apply shot peening or barrel finishing between the cold forging/punching steps and the heat treatment step.

The shot peening is a type of blasting which accelerates steel balls (shots) with air pressure or a centrifugal force, and hits the tooth flanks with them. This generates residual compressive stress on the tooth flanks so as to smooth the tooth flanks, and simultaneously increases durability with work hardening.

The barrel finishing is to grind and polish the surface of the external gear by mixing abrasives and chemicals (compound) in a tank (a barrel), and applying rotation and vibration so as to generate a relative motion between the external gear and the abrasives in the tank. It is also expected to increase the durability by smoothing the surface and work hardening as a result of the barrel finishing.

When a process applying shot peening or barrel finishing to the tooth flanks after the cold forging is added, the tooth flanks in the tooth profile direction is especially smoothed, and a sectional shape in the tooth trace direction is formed so as to more easily hold the lubricant.

As described above, according to the present invention, since the tooth profile is formed with cold forging, the machining becomes easy, and thus the manufacturing cost is reduced.

Since the roughness of the tooth flanks in the tooth profile formed by the cold forging is maintained on the completed product before assembling the completed product into the power transmission mechanism, it is possible to largely increase the capability of holding the lubricant on the tooth flanks when the product is assembled into the power transmission mechanism. As a result, the friction resistance and the noise are reduced, and thus, the characteristics as this type of the external gear are maintained at a level proper for an actual application for a long period. Since it is expected that the cold forging applies work hardening to the tooth flanks, the product can be simply applied to a power transmission mechanism with a low load and the like even if the heat treatment is skipped in the later step, and consequently, the product is supplied at a low price.

Further, when the holes required for constituting the power transmission mechanism are formed in the punching step, since the cold forging step and the punching step are conducted with respective single chucks, it is easy to maintain the position precision of the tooth profile and the individual holes.

What is claimed is:

1. A method for fabricating an external-tooth gear internally in mesh with an internal gear inside said internal gear, the method comprising:
a cold forging step of forming a material into a disc, and simultaneously forming teeth on an outer periphery of said disc by a cold forging technique; and
a step of forming a hole required for constituting a power transmission mechanism on the disc obtained in said cold forging step, wherein
surface roughness of tooth flanks caused by said cold forging is maintained on a completed product.

2. A method for manufacturing fabricating an external-tooth gear internally in mesh with an internal gear inside said internal gear, the method comprising:
a cold forging step of forming a material into a disc, and simultaneously forming teeth on an outer periphery of said disc by a cold forging technique; and
a punching step of forming a hole required for constituting a power transmission mechanism on the disc obtained in said cold forging step by a punching technique, wherein
surface roughness of tooth flanks caused by said cold forging step is maintained on a completed product.
